(19) United States
(12) Patent Application Publication
(10) Pub. No.: US 2011/0058219 A1
(43) Pub. Date: Mar. 10, 2011

(54) Printer driver, information processing apparatus, and computer program product

(75) Inventor: Naoki Fukasawa, Kanagawa (JP)

(73) Assignee: Ricoh Company, Limited

(21) Appl. No.: 12/923,092

(22) Filed: Sep. 1, 2010

(30) Foreign Application Priority Data
Sep. 9, 2009 (JP) 2009-208509

(51) Int. Cl. G06F 3/12

(52) U.S. Cl. 358/1.15

(57) ABSTRACT

A printer driver includes: a receiving unit that receives an event for requesting a printer to perform a process; a command generating unit that generates, when the receiving unit has received the event, a command for causing the printer to execute the event based on a script in which a process for generating the command is written; and an outputting unit that performs control to output the command generated by the command generating unit to the printer.

### CROSS-REFERENCE TO RELATED APPLICATIONS

The present application claims priority to and incorporates by reference the entire contents of Japanese Patent Application No. 2009-208509 filed in Japan on Sep. 9, 2009.

### BACKGROUND OF THE INVENTION

1. Field of the Invention

The present invention relates to a printer driver, an information processing apparatus, and a computer program product that are capable of adding, deleting, or changing a function related to printing.

2. Description of the Related Art

Conventionally, various commands have been used to issue a print instruction from a host computer such as a PC to a printer. As types of the commands, PJL (Printer Job Language), JDF (Job Definition Format), and the like as commands for making a setting of a printer, a setting for page aggregation, a setting for duplex printing, or the like on the printer have been known in addition to a drawing command for instructing the printer to perform drawing.

The command such as PJL is written in text and is used for making a finisher setting or the like that is not contained in drawing data. The PJL command itself is not a command specialized for each printer but is generally a command common to a plurality of printers. However, in recent years, any types of printers to be delivered are increasingly equipped with different functions to meet users' needs. Therefore, a command used for making the finisher setting differs for each printer.

Meanwhile, a printer driver for calling the printer is installed on the host computer connected to the printer, and the host computer is allowed to use a function of the printer by calling the printer driver. In other words, the printer driver generates a command corresponding to the function according to a request by the host computer and then outputs the command to the printer, so that the function of the printer is made available.

Because of the above configuration, when a new command or a new function is added to the printer, it is necessary to update the printer driver installed on each host computer that controls the printer. The printer driver is generally distributed in a compiled binary format.

Incidentally, when a new command or a new function is added to the printer, it is necessary for a programmer to rewrite, recompile, and redistribute the computer programs of the printer driver. Then, after the distributed printer driver is installed on the host computer, the host computer is allowed to use the newly-added command and function.

However, in the conventional technology described above, because the printer driver is a compiled binary, there is a problem in that it is necessary to rewrite, recompile, and redistribute the computer programs of the printer driver every time a function of the printer is added or deleted. Therefore, a workload is increased.

A technology for allowing a printer driver to add a command for a plurality of types of apparatuses without compilation is disclosed in, for example, Japanese Patent Application Laid-open No. 2008-9967. In the technology disclosed in Japanese Patent Application Laid-open No. 2008-9967, a command is acquired based on apparatus information read from the printer, and print data that is interpretable by the printer is generated based on the command.

However, in the technology disclosed in Japanese Patent Application Laid-open No. 2008-9967, because the printer driver is required to read the apparatus information out from the printer, it is necessary to store the apparatus information in advance in the printer.

Besides, there is a conventionally-known problem in that the printer driver needs to be reinstalled when a different command is to be tested to cause the printer to perform printing at the time of maintenance of the printer, leading to an increased workload. In this regard, in the technology disclosed in Japanese Patent Application Laid-open No. 2008-9967, it is difficult to test a different command at the time of maintenance, and it is also difficult to resolve the problem with the increased workload.

### SUMMARY OF THE INVENTION

It is an object of the present invention to at least partially solve the problems in the conventional technology.

According to an aspect of the present invention, there is provided a printer driver including: a receiving unit that receives an event for requesting a printer to perform a process; a command generating unit that generates, when the receiving unit has received the event, a command for causing the printer to execute the event based on a script in which a process for generating the command is written; and an outputting unit that performs control to output the command generated by the command generating unit to the printer.

According to another aspect of the present invention, there is provided an information processing apparatus including: a storage unit that stores therein a script in which a process for generating a command to be executed by a printer is written; a receiving unit that receives an event for requesting the printer to perform a process; a command generating unit that generates, when the receiving unit has received the event, the command based on the script stored in the storage unit; and an outputting unit that performs control to output the command generated by the command generating unit to the printer.

According to still another aspect of the present invention, there is provided a computer program product including a computer-usable medium having computer-readable program codes embodied in the medium for executing the printer driver that is above mentioned.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of an information processing apparatus according to a first embodiment;

FIG. 2 is a diagram illustrating a correspondence relation between an event held by an event holding unit of the information processing apparatus and a name of a script file to be executed in the event;

FIG. 3 is a diagram illustrating an example of a script stored in a script-file storage unit of the information processing apparatus;

FIG. 4 is a table containing set values of “ORIENTATION” which are obtained based on initial set values of “orientation” and set values of “layout”;

FIG. 5 is a diagram illustrating setting list data before filtering is performed by a filtering unit and setting list data after the filtering is completed;

FIG. 6 is a diagram for explaining updating of a script file in the information processing apparatus according to the first embodiment;

FIG. 7 is a diagram illustrating a relation between values of “STAPLE” needed to be set due to addition of a staple function and values of parameters corresponding to the values of “STAPLE”;

FIG. 8 is a diagram illustrating an example of a script to which the staple function is added;

FIG. 9 is a sequence diagram of a procedure of a process performed at the start of a job by the information processing apparatus according to the first embodiment;

FIG. 10 is a flowchart of a detailed procedure of a process performed at Step S904 of FIG. 9 by the information processing apparatus according to the first embodiment;

FIG. 11 is a flowchart of a procedure of a process performed at the end of the job by the information processing apparatus according to the first embodiment; and

FIG. 12 is a diagram illustrating a hardware configuration of the information processing apparatus.

### DETAILED DESCRIPTION OF THE PREFERRED EMBODIMENTS

Exemplary embodiments of the present invention will be explained in detail below with reference to the accompanying drawings.

### First Embodiment

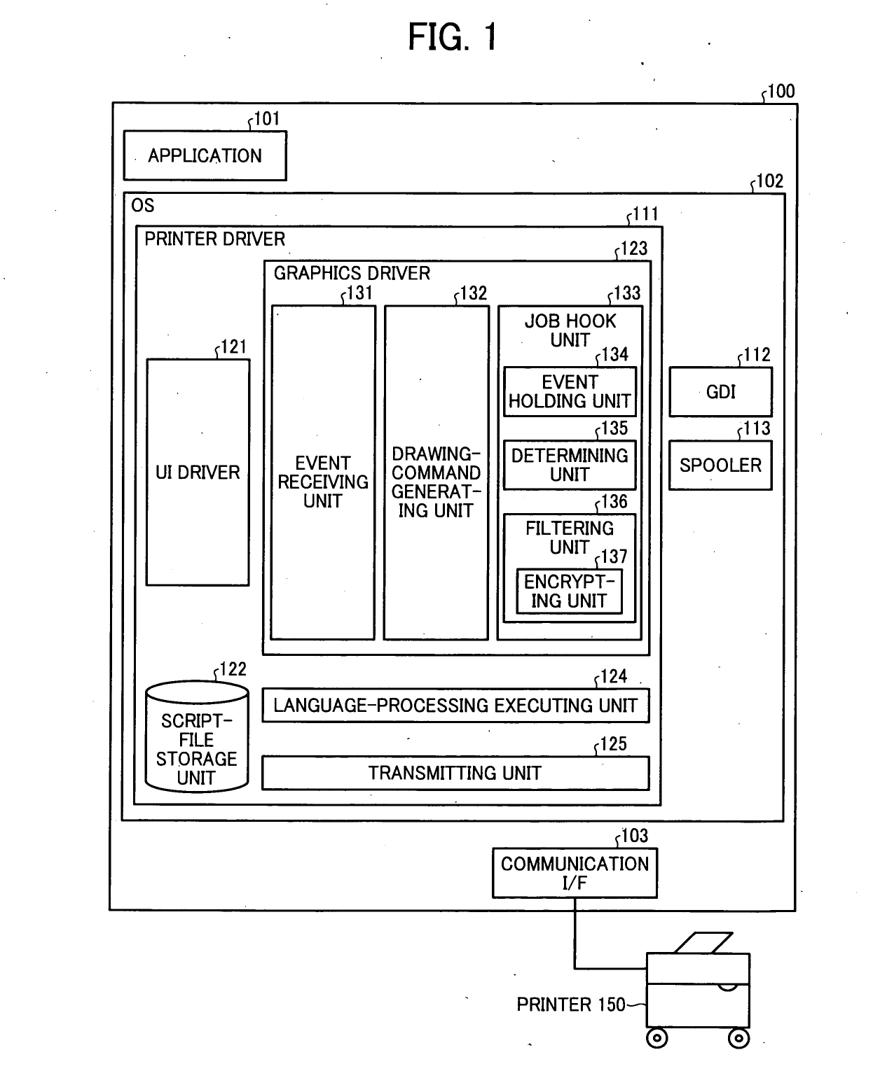

FIG. 1 is a block diagram of a configuration of an information processing apparatus according to a first embodiment of the present invention. As illustrated in FIG. 1, an information processing apparatus 100 includes an application 101, an OS 102, and a communication I/F 103. The communication I/F 103 is connected to a printer 150 via a network. Therefore, the information processing apparatus 100 is allowed to issue a print request to the printer 150.

The printer 150 performs a printing process according to a print request input from an operating unit (not illustrated) which is included in the printer 150. Furthermore, the printer 150 includes an interface for connecting to the information processing apparatus 100, and performs a printing process according to a print request issued by the information processing apparatus 100 connected thereto via the network. A multifunction peripheral having at least two functions from among a copy function, a printer function, a scanner function, and a facsimile function is applied to the printer 150 of the embodiment. However, a printer that performs only a printing process is also applicable instead of the multifunction peripheral.

In particular, recent multifunction peripherals are increasingly configured to facilitate easy addition and deletion of a function based on a request by a user. For example, when a user wants to add a staple function, he or she only has to contact a maintenance provider of the printer. Accordingly, the maintenance provider installs a computer program or the like to add the function (e.g., the staple function) to the printer to thereby make the function available. When such a function (e.g., the staple function) is added, and if the information processing apparatus is to use the added function, a printer driver corresponding to the function becomes necessary.

However, because the printer driver is provided in a binary format, it has been necessary to rewrite a computer program, recompile the printer driver, and reinstall the printer driver in order to handle the function that has been added to the printer. Therefore, in the embodiment, a technology for reducing the above-mentioned workload will be proposed.

The application 101 of the information processing apparatus 100 is software that runs on the OS 102 to be described later, and issues a print request to the inside of the OS 102.

The OS 102 includes a printer driver 111, a GDI (Graphics Device Interface) 112, and a spooler 113, and controls the whole information processing apparatus 100.

The GDI 112 is one of sub systems included in the OS 102, and performs a drawing process. When the OS 102 receives a print request from the application 101 or the like, the GDI 112 calls the printer driver 111 to request a printing process.

The spooler 113 is one of the sub systems included in the OS 102, and is assumed to be a module for temporarily accumulating print jobs to be transmitted to the printer 150.

The printer driver 111 includes a UI driver 121, a script-file storage unit 122, a graphics driver 123, a language-processing executing unit 124, and a transmitting unit 125, so that it performs a process for issuing a print request to the printer 150.

The UI driver 121 is one of modules constituting the printer driver 111, and performs operation of displaying a GUI for making various settings of the printer 150, displaying an initial setting screen at the time of installation, receiving operations performed on the displayed GUI or the displayed initial setting screen, or the like.

The script-file storage unit 122 stores therein a group of text files containing written scripts that are executable by the language-processing executing unit 124 to be described later. The script file contains a script which is written as text and used for generating a command to be executed by the printer 150. In the embodiment, the lua format is applied as a format of the script file. However; various formats may be applied whether or not the formats are conventionally-known or not.

As the means of using the script file, any means can be applied. For example, it is possible to configure so that the script file is deployed on the OS 102 as a text file, or a plurality of text files are compressed into a single archive file and extracted on a memory (not illustrated) or a file system (not illustrated) at the time of execution. Details about the script file will be described later.

The graphics driver 123 includes an event receiving unit 131, a drawing-command generating unit 132, and a job hook unit 133, is one of the modules constituting the printer driver 111 so that it mainly performs a drawing process.

The event receiving unit 131 receives an event for requesting the printer 150 to perform a process. For example, the event receiving unit 131 receives various drawing events from the GDI 112. When receiving an event, the event receiving unit 131 requests the drawing-command generating unit 132 to generate a drawing command.

The drawing-command generating unit 132 generates a drawing command according to the received event. The drawing command is composed of two commands as described below.

That is, one is a print command in which data of a printing object such as a line or a graphics image is written. The other is a job command which is not related to the printing object and in which various types of job information, such as a finisher setting, a job name, or a user name, are written for each vendor.

Among the drawing commands as described above, the print command is a command specialized for each printer 150, and is handled within the drawing-command generating unit 132. On the other hand, among the drawing commands, the job command is a command defined as a standard such as PJL (Printer Job Language). Thus, the job command is not a command specialized for each printer but is generally a common command. Therefore, in the embodiment, the job command is generated by using the script file so that the job command to be executed can be made editable.

Examples of the job command include a setting of the number of copies, a setting for punching, a setting for duplex printing, a setting for page aggregation (e.g., 2 in 1), and a setting for stapling. Furthermore, the script file may be edited by, for example, adding, changing, or deleting a command, changing an argument to be passed to each command, or changing a parameter for making an environmental setting.

When generating a job command corresponding to an event of job start, job end, document start, document end, physical page start, physical page end, logical page start, or logical page end, the drawing-command generating unit 132 requests the job hook unit 133 to generate the command.

Furthermore, when generating print commands corresponding to other events, the drawing-command generating unit 132 itself generates the commands. As the means of generating the print commands, a conventionally-known means is applicable, and therefore, explanation of the means is not described herein.

More specifically, when receiving a drawing command, the event receiving unit 131 requests the drawing-command generating unit 132 to generate a corresponding drawing command. In this case, when the received event is related to printing, the drawing-command generating unit 132 itself generates the command; and, when the received event is related to a job, the drawing-command generating unit 132 requests the job hook unit 133 to generate the command.

Furthermore, the drawing-command generating unit 132 reads the DEVMODE structure or the PrinterDriverData registry to thereby generate setting list data. The setting list data is assumed to be information containing a setting parameter related to printing. When requesting the job hook unit 133 to generate the command, the drawing-command generating unit 132 also passes the setting list data.

The job hook unit 133 includes an event holding unit 134, a determining unit 135, a filtering unit 136, and an encrypting unit 137 so that it generates a job command according to a job-command generation request from the drawing-command generating unit 132. The job hook unit 133 of the embodiment executes a script file corresponding to a job command which is requested to be generated to thereby generate the job command. A configuration for identifying a script file is explained below. Note that the script is executed by the language-processing executing unit 124.

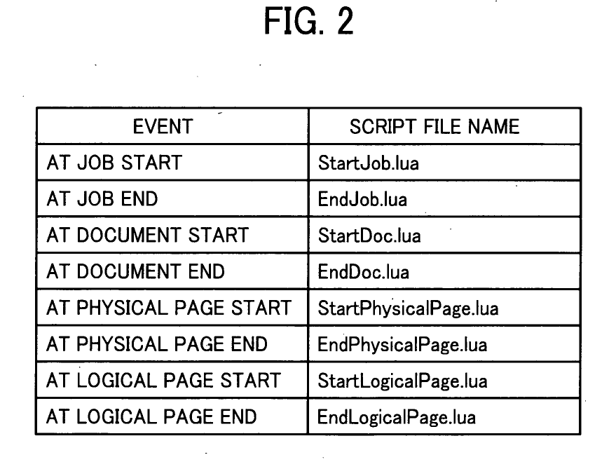

The event holding unit 134 holds a name of a script file to be executed in association with each event. FIG. 2 is a diagram illustrating a correspondence relation between an event held by the event holding unit 134 and a name of a script file to be executed in the event. In other words, it is possible to identify a script file to be executed based on a received event.

Referring back to FIG. 1, the determining unit 135 determines whether the event received by the event receiving unit 131 is a predetermined event that requires execution of a script file. More specifically, whether the received event is held by the event holding unit 134 or not is determined to determine whether the received event requires execution of a script file. When determining that the event requires the execution, the determining unit 135 further determines whether a script file corresponding to the event is stored in the script-file storage unit 122 or not. Only when the script file is stored in the script-file storage unit 122, the script file is executed.

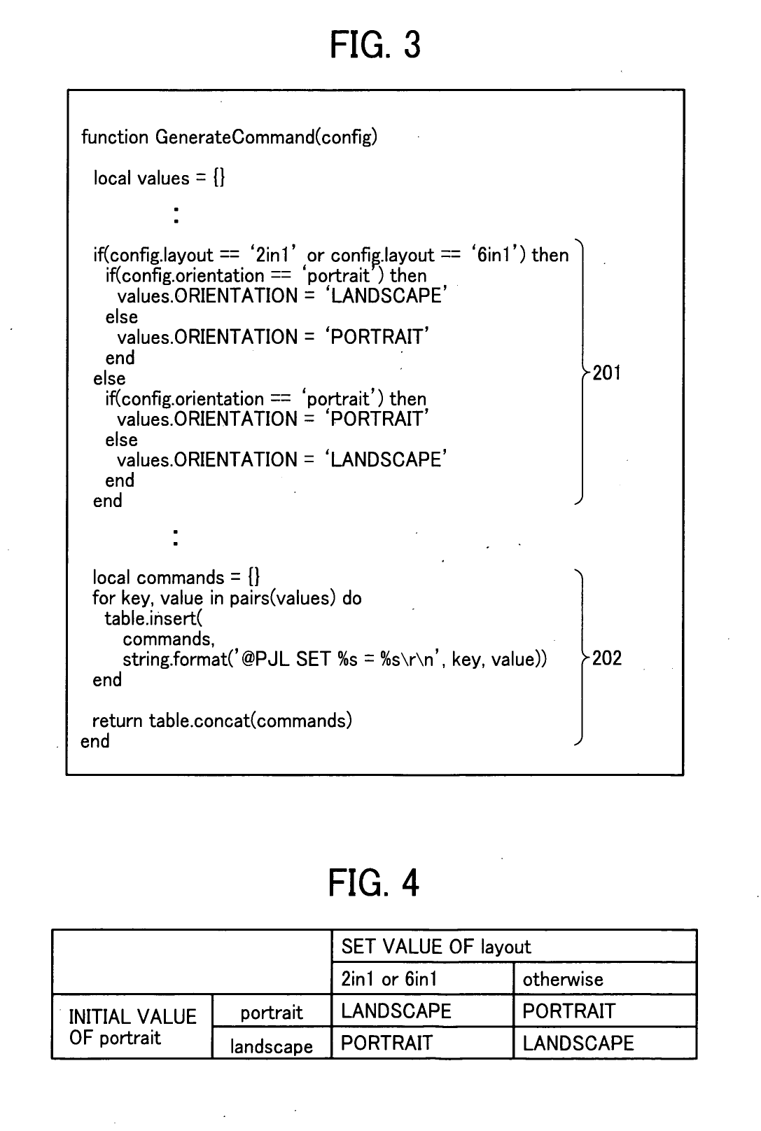

Furthermore, when the event receiving unit 131 receives an event, the determining unit 135 identifies a script file corresponding to the event, and the language-processing executing unit 124 to be described later executes the identified script file. In the embodiment, an example is explained in which a script file associated with each event is executed. In the embodiment, it is also assumed that a name of a function to be executed is determined in advance, and more particularly, the name is assumed to be “GenerateCommand”. The job hook unit 133 calls a function with this function name regardless of the script file that has been called. An example of the script to be called is illustrated in FIG. 3. In FIG. 3, “config” is set as an argument. It is assumed that the “config” represents the setting list data which is converted into a lua table format by the filtering unit 136. Therefore, it is possible to pass each parameter of the setting list data to the script file.

Next, the script file is explained in detail below. FIG. 3 is a diagram illustrating an example of a script file “StartJob.lua” stored in the script-file storage unit 122. In the script file illustrated in FIG. 3, a script to be executed at the start of a job is illustrated as an example. In the example of FIG. 3, either “PORTRAIT” or “LANDSCAPE” is set for a parameter “ORIENTATION” in each row indicated by a symbol 201. It is assumed that “ORIENTATION” is a parameter for setting an orientation of a paper, “PORTRAIT” is a value for indicating that a paper is placed in a portrait orientation, and “LANDSCAPE” is a value for indicating that a paper is placed in a landscape orientation. When 2 in 1 for example is performed, “PORTRAIT” and “LANDSCAPE” in “ORIENTATION” are switched from one to the other depending on a layout region for page aggregation.

FIG. 4 is a table containing set values of “ORIENTATION” which are obtained based on initial set values of “orientation” and set values of “layout”. As illustrated in FIG. 4, when the initial set value of “orientation” is “PORTRAIT” and the set value of “layout” is “2 in 1” or “6 in 1”; it is necessary to set “LANDSCAPE” to “ORIENTATION”. Furthermore, when the initial set value of “orientation” is “PORTRAIT” and the set value of “layout” is other than “2 in 1” and “6 in 1”, it is necessary to set “PORTRAIT” to “ORIENTATION”.

Moreover, when the initial set value of “orientation” is “LANDSCAPE” and the set value of “layout” is “2 in 1” or “6 in 1”, it is necessary to set “PORTRAIT” to “ORIENTATION”. Furthermore, when the initial set value of “orientation” is “LANDSCAPE” and the set value of “layout” is other than “2 in 1” and “6 in 1”, it is necessary to set “LANDSCAPE” to “ORIENTATION”.

The script file “StartJob.lua” illustrated in FIG. 3 contains a script to be executed at the start of a job, and the above-mentioned values of “ORIENTATION” are set in each row indicated by the symbol 201. Each row indicated by a symbol 202 contains a statement for generating a job command by PJL, and “@PJL SET ORIENTATION=PORTRAIT” is generated as a job command for the above-mentioned example.

As described above, because a command is generated by using a script in the lua format, it is possible to generate the command under flexible conditions even when one-to-one correspondence is not established between the set value and the command. In this case, because generation of the command can be written in text, ease of maintenance can be enhanced.

In the example illustrated in FIG. 3, the set value of the ORIENTATION command can be determined by referring to the set value of layout and the initial value of orientation held in the config.

However, instead of preparing a script file for each event as has been described in the embodiment, it is possible to prepare only a single script file and call a function with a function name determined in advance for each event.

Referring back to FIG. 1, the filtering unit 136 includes the encrypting unit 137, and performs addition, deletion, or the like of a parameter with respect to the setting list data to be passed to the script file. The filtering unit 136 then passes the setting list data with the added or the deleted parameter to the script file.

The encrypting unit 137 performs an encryption process on the parameter contained in the setting list data. The parameter that has been subjected to the encryption process is passed as the setting list data to the script file. The encrypting unit 137 performs the encryption process such that the printer 150 being an output destination can decrypt the encrypted object. In other words, because a user is allowed to rewrite the script file, if a password is not encrypted, information leakage may occur. Therefore, before passing the script file, the encrypting unit 137 performs the encryption process such that the printer 150 can decrypt the encrypted object. Consequently, it is possible to prevent leakage of the password even when the script file is maliciously rewritten.

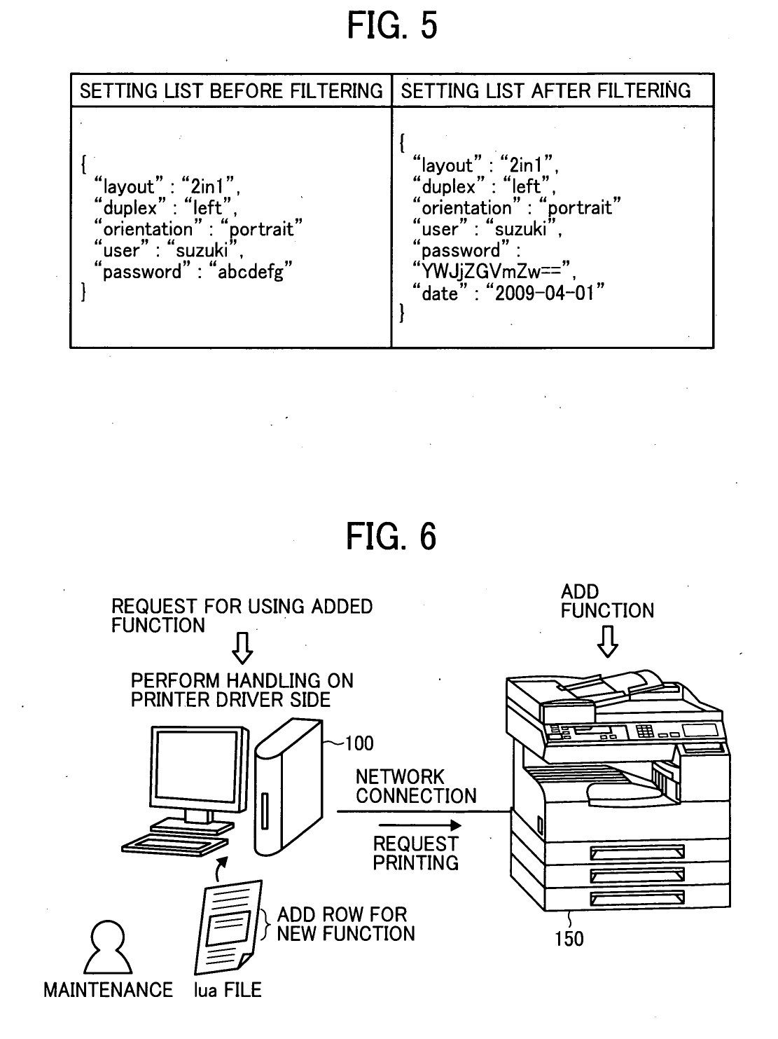

FIG. 5 is a diagram illustrating setting list data before filtering (transforming) is performed by the filtering unit 136 and setting list data after the filtering is completed. As illustrated in FIG. 5, the setting list data of the embodiment is written in the JSON format as an example. However, the present invention is not limited to the JSON format, and the setting list data can be written in any formats. For example, the setting list data may be written in a format of text data written in the INI file format or the XML format, or a format of a link list of a structure.

In the example illustrated in FIG. 5, the encrypting unit 137 performs the encryption process on “password” and adds “date” to the setting list data before filtering of FIG. 5. Then, the filtered setting list data is output to the language-processing executing unit 124, so that the setting list data is passed to the script file.

When the event receiving unit 131 receives an event, the language-processing executing unit 124 reads a script file associated with the event from the script-file storage unit 122 and executes the script file to thereby generate a command to be output to the printer. In other words, the language-processing executing unit 124 generates the command based on the script file, which means that the language-processing executing unit 124 functions as a command generating means. Besides, the language-processing executing unit 124 functions as an interpreter of a scripting language “lua”. The language-processing executing unit 124 passes, as an argument, the setting list data input by the filtering unit 136 to the script file. In other words, the language-processing executing unit 124 also functions as a passing means. Therefore, because the script file to which each parameter contained in the setting list data has been passed is executed, it is possible to generate a command appropriate for the printer to which the command is to be output.

The transmitting unit 125 performs control to output a group of commands generated by the language-processing executing unit 124 to the printer. More specifically, the transmitting unit 125 outputs the group of the generated commands to the spooler 113. The group of the commands accumulated in the spooler 113 is eventually transmitted to the printer 150. As a process of transmitting the commands from the spooler 113 to the printer 150, a conventionally-known method is applicable, and therefore, explanation of the process is not described herein.

FIG. 6 is a diagram for explaining updating of a script file in the information processing apparatus 100 according to the first embodiment. As illustrated in FIG. 6, the information processing apparatus 100 and the printer 150 are connected to each other via a network. As described above, a function is added to the printer 150 according to a request by a user. In this case, there is a reasonable demand for using the added function when printing is performed via the information processing apparatus 100. When use of the added function is demanded, the printer driver 111 needs to be able to handle the added function. Therefore, in the conventional technology, a printer driver capable of handling the added function has been installed.

However, installation of the printer driver on the information processing apparatus 100 increases the workload, and in the first place, it is necessary to generate a computer program corresponding to the added function in advance. Therefore, in the printer driver 111 of the embodiment, a script file “*.lua” for generating a command as described above is prepared. In other words, with the printer driver 111 of the embodiment, when a function is added to the printer 150 connected to the network, it is possible to allow the information processing apparatus 100 to use the added function by adding a row corresponding to the function to the script file stored in the information processing apparatus 100.

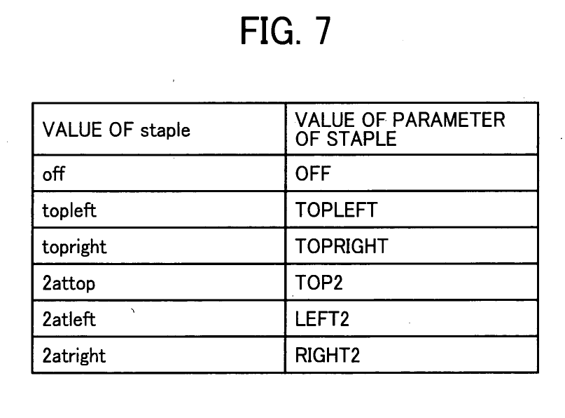

For example, when a staple function is added to the printer 150 and it is desired to use the staple function, it is necessary to set a value of “STAPLE” illustrated in FIG. 7 and a value of a parameter corresponding to the value of “STAPLE”.

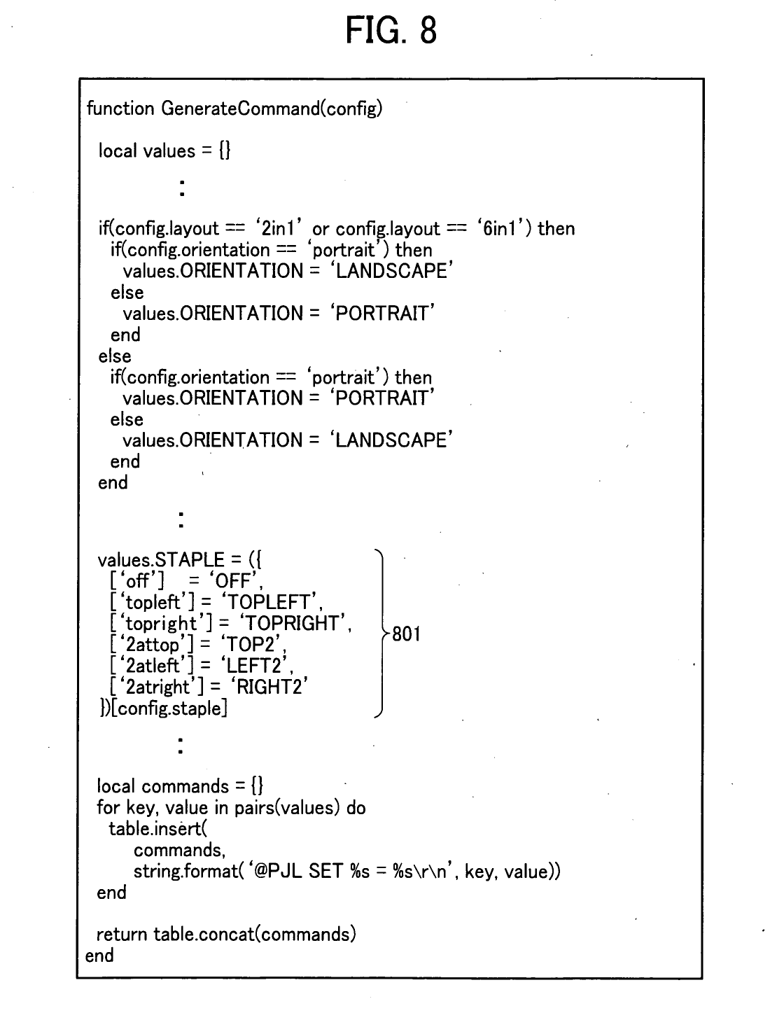

FIG. 8 is a diagram illustrating an example of a script to which rows for handling the staple function are added. In the script file illustrated in FIG. 8, rows indicated by a symbol 801 are added to the script file illustrated in FIG. 2. The staple function can be made available by causing the language-processing executing unit 124 to execute the script file illustrated in FIG. 8. The function to be added is not limited to the staple function, and various functions may be added.

It is also possible to edit the script file more flexibly. For example, even when stapling with only two holes is available by the staple function before editing, stapling with three, four, or more holes may become available by editing.

In addition to the case in which a function is added to the printer 150, there is also a case needed to be dealt with in which a person who performs maintenance may want to add, change, or delete a command to be output by the printer driver 111 in order to check the printer 150 of a client. In such a case, the conventional printer drivers are less customizable because they are distributed in a compiled binary format. Therefore, it is extremely difficult to change the command. In contrast, in the embodiment, a section for generating a PJL command is held as the script file. Therefore, it is possible to control the command to be output to the printer 150 by editing the script file. Consequently, even when it is desired to change a job command to be output, it is possible to dynamically change a command to be output without recompilation or reinstallation of the printer driver 111. As a result, the customizability can be enhanced.

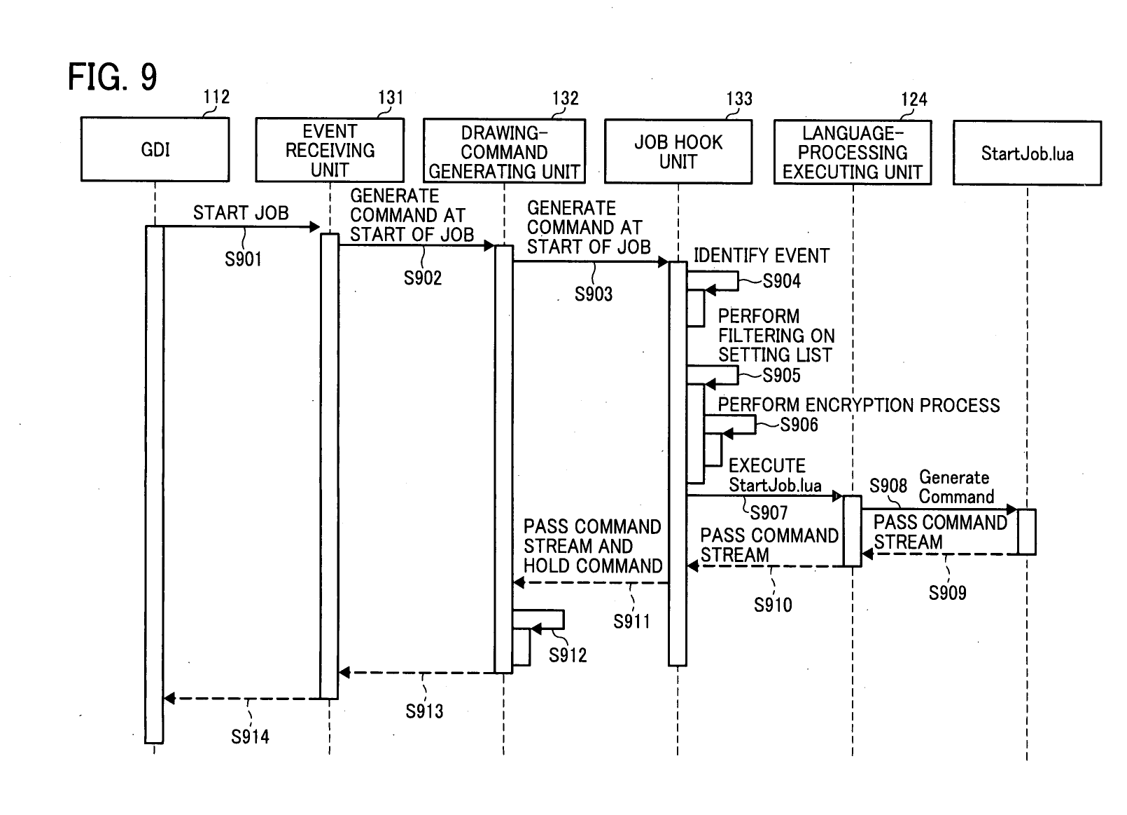

Described below is a process performed at the start of a job by the information processing apparatus 100 having the above configuration according to the embodiment. FIG. 9 is a sequence diagram of a procedure of a process at the start of a job by the information processing apparatus 100 according to the first embodiment.

The GDI 112 sends an event for requesting a start of a job to the event receiving unit 131 (Step S901). The event receiving unit 131 receives the event, and accordingly requests the drawing-command generating unit 132 to generate a job command at the start of the job (Step S902). The drawing-command generating unit 132 that has received the request reads the DEVMODE structure or the PrinterDriverData registry, and generates the setting list data before filtering as illustrated in FIG. 5.

Subsequently, the drawing-command generating unit 132 requests the job hook unit 133 to generate a command at the start of the job (Step S903). At this time, the generated setting list data is passed to the job hook unit 133.

The determining unit 135 of the job hook unit 133 determines whether execution of a script file corresponding to the event is necessary or not (Step S904). This determination is performed by determining whether the event requires execution of the script file or whether the script file corresponding to the event is present. A detailed process will be described later. In the sequence diagram, a case is explained in which the script file is determined to be executed. When it is determined that the script file is not to be executed, the process ends without performing subsequent processes.

When it is determined that the script file is to be executed, the filtering unit 136 performs filtering on part of parameters contained in the passed setting list data (Step S905). Because of the filtering, a necessary parameter such as date information “Date” which is not contained in the DEVMODE structure or the PrinterDriverData registry is added. Furthermore, the encrypting unit 137 performs the encryption process on a parameter such as a password among the parameters contained in the setting list data (Step S906). Consequently, “password” written in plaintext in the setting list data is encrypted by the encryption process in conformity with a format to be transmitted to the main body of the printer 150. This is performed to prevent a malicious person from rewriting the script file or collecting a user's password.

The job hook unit 133 executes the script file that is determined to be present at Step S904 (Step S907). At the same time, the job hook unit 133 instructs the language-processing executing unit 124 on a name of a predetermined function to be executed.

Subsequently, the language-processing executing unit 124 calls a function with the instructed function name (GenerateCommand( )) held by the called script file (StartJob.lua) (Step S908). Then, the StartJob.lua, executed by the language-processing executing unit 124, generates a command stream based on the called function, and passes the command stream to the language-processing executing unit 124 (Step S909). In other words, the language-processing executing unit 124 generates the command stream based on the StartJob.lua. When no command is generated as a result of the execution, a blank stream is returned and the process ends.

The language-processing executing unit 124 outputs the passed command stream to the job hook unit 133 (Step S910). Subsequently, the job hook unit 133 also outputs the input command stream to the drawing-command generating unit 132 (Step S911). The drawing-command generating unit 132 stores the input command stream in a memory not illustrated (Step S912). Then, the drawing-command generating unit 132 notifies the event receiving unit 131 of the end of the process (Step S913). Further, the event receiving unit 131 notifies the GDI 112 of the end of the process (Step S914).

According to the process procedure described above, generation of the command at the start of the job is completed. By executing the script file as described above, a command appropriate for the execution of the job can be generated.

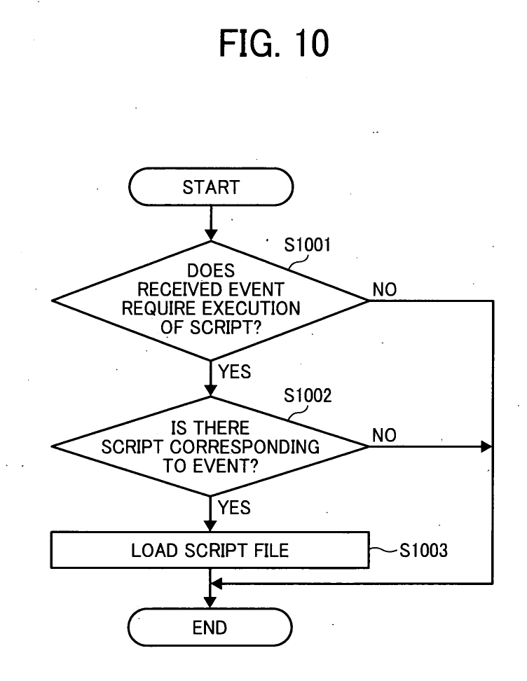

Next, details of the process performed at Step S904 by the information processing apparatus 100 of the embodiment are explained below. FIG. 10 is a flowchart of a detailed procedure of the process performed at Step S904 of FIG. 9 by the information processing apparatus 100 according to the embodiment.

The determining unit 135 determines whether the received event is an event that requires execution of a script file based on the event holding unit 134 (Step S1001). When it is determined that the event does not require the execution (NO at Step S1001), the process ends.

On the other hand, when it is determined that the event requires the execution (YES at Step S1001), the determining unit 135 determines whether a script file corresponding to the event is present or not (Step S1002). When it is determined that the script file is not present (NO at Step S1002), the process ends.

On the other hand, when it is determined that the script file to be executed is present (YES at Step S1002), the script file is loaded (Step S1003). Accordingly, the language-processing executing unit 124 is allowed to execute the script file.

According to the process procedure described above, it is sufficient that a script file is prepared only for an event that requires insertion of a command. Therefore, the customizability can be enhanced.

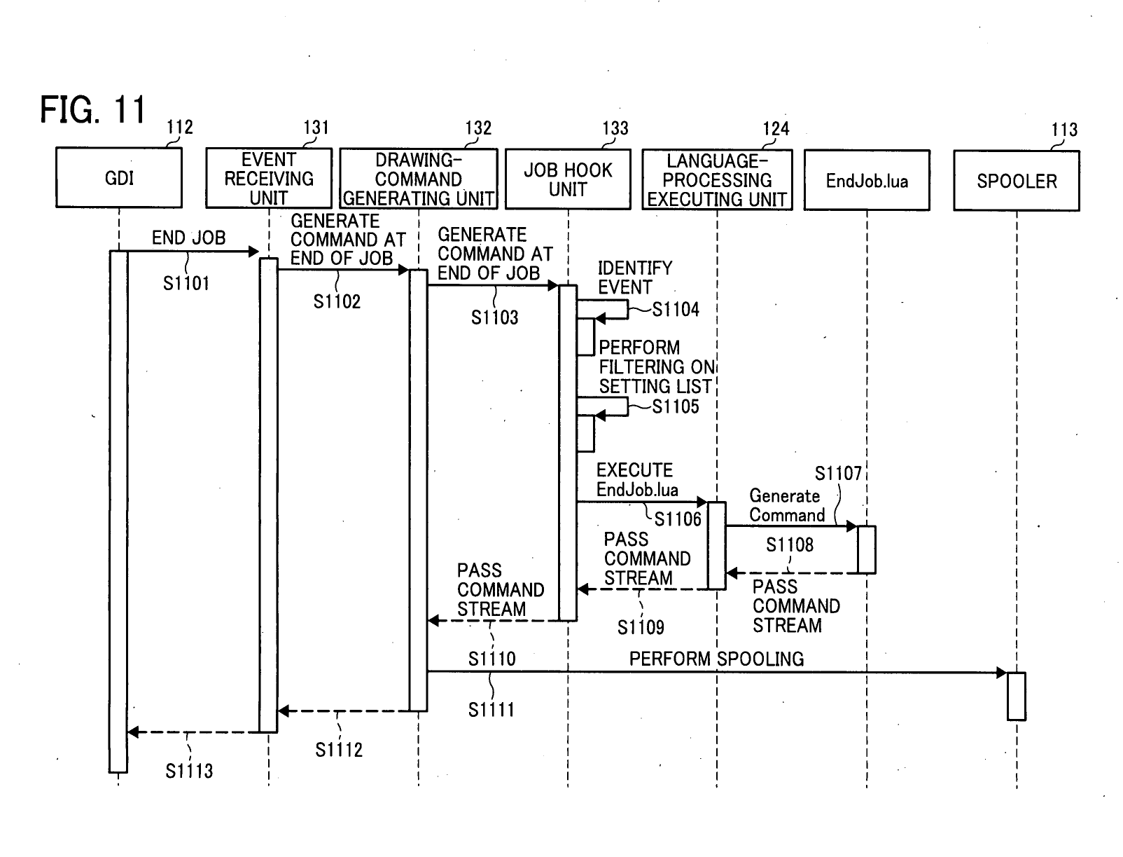

Described below is a process performed at the end of a job by the information processing apparatus 100 having the above configuration according to the embodiment. FIG. 11 is a flowchart of a procedure of a process performed at the end of the job by the information processing apparatus 100 according to the first embodiment.

The GDI 112 sends an event for requesting the end of a job to the event receiving unit 131 (Step S1101). The event receiving unit 131 receives the event, and accordingly requests the drawing-command generating unit 132 to generate a job command at the end of the job (Step S1102). The drawing-command generating unit 132 that has received the request reads the DEVMODE structure or the PrinterDriverData registry, and generates the setting list data.

Subsequently, the drawing-command generating unit 132 requests the job hook unit 133 to generate a command at the end of the job (Step S1103). At this time, the generated setting list data is passed to the job hook unit 133.

The determining unit 135 of the job hook unit 133 determines whether execution of a script file corresponding to the event is necessary or not (Step S1104). This determination is the same as that of Step S904 of FIG. 9. In this sequence diagram, a case is explained in which the script file is determined to be executed.

When it is determined that the script file is to be executed, the filtering unit 136 performs filtering on part of parameters contained in the received setting list data (Step S1105). This filtering is assumed to include the encryption process illustrated in FIG. 9, or the like.

Then, the job hook unit 133 executes the script file that is determined to be present at Step S1104 (Step S1106). At the same time, the job hook unit 133 instructs the language-processing executing unit 124 on a name of a predetermined function to be executed.

Subsequently, the language-processing executing unit 124 calls a function with the instructed function name (GenerateCommand( )) held in the called script file (EndJob.lua) (Step S1107). Then, the EndJob.lua executed by the language-processing executing unit 124 generates a command stream based on the called function, and passes the command stream to the language-processing executing unit 124 (Step S1108). In other words, the language-processing executing unit 124 generates the command stream based on the EndJob.lua. When no command is generated as a result of the execution, a blank stream is returned and the process ends.

The language-processing executing unit 124 outputs the passed command stream to the job hook unit 133 (Step S1109). Subsequently, the job hook unit 133 also outputs the input command stream to the drawing-command generating unit 132 (Step S1110). Then, the transmitting unit 125 sends a command stream that has been held since the start of the job to the spooler 113 to cause the spooler 113 to perform spooling (Step S1111).

The drawing-command generating unit 132 notifies the event receiving unit 131 of the end of the process (Step S1112). Further, the event receiving unit 131 notifies the GDI 112 of the end of the process (Step S1113).

According to the process procedure described above, the generated command is stored in the spooler 113. Then, the spooler 113 outputs the spooled command to the printer 150 at a predetermined timing, so that the command is executed by the printer 150.

As described above, in the printer driver 111 of the embodiment, because the script file holds a section for generating a PJL command, it is possible to dynamically change a job command to be output to the printer 150. Therefore, it is not necessary to generate or recompile the printer driver 111 when a function is added, so that efficiency in development can be enhanced. Furthermore, the printer driver 111 of the embodiment is able to reduce the workload for changing a command to be transmitted to the printer 150.

Moreover, in the embodiment, a command can be generated by using a script such as the lua language. Therefore, compared with use of a table which contains a set value and a command to be executed at the set value in an associated manner, it is possible to set a command generated by a complex logic. As a result, it is possible to more appropriately generate a command depending on a situation.

The present invention is not limited to the embodiment described above, and may be modified in various forms as described below as an example.

### Modified Example 1

In the first embodiment described above, an example is explained, in which the language-processing executing unit 124 as an interpreter that executes the script file is held within the printer driver 111. However, the present invention is not limited to the embodiment described above, and it can be configured to execute the script file outside the printer driver 111. As an example of the execution outside the printer driver, a structural module stored in a browser may be used as a processing system of a script file (e.g., Jscript). Therefore, as a modified example, an example is explained in which the browser executes the script file.

In the above embodiment, an example is explained in which the interpreter is held within the printer driver 111. However, the means of executing the script file is not limited to this embodiment. For example, it can be configured to use a processing system of a script file (e.g., Jscript) as a structural module stored in the browser. In this case, the language-processing executing unit described above is configured not to function as the interpreter but to call the module of the browser.

In the printer driver of the modified example, it is possible to execute the script file by causing the language-processing executing unit to read the browser. In this case, the script file needs to be in a format readable by the browser instead of the lua format. For example, the script file may be in the Jscript format. The job hook unit identifies a script file corresponding to an event, and the language-processing executing unit requests the browser to execute the script file. At this time, the setting list data as described above is also passed as an argument. Consequently, a command is generated by causing the structural module included in the browser (a script execution engine) to execute the script file. The command generated by the browser is received by the job hook unit of the modified example. As a result, even when the script file is executed outside of the printer driver, the same advantages as those of the first embodiment can be achieved. Other processes are the same as those of the first embodiment, and therefore, explanation thereof is not repeated. In the modified example, an engine for reading the script file is not needed, so that load on development of the printer driver 111 can further be reduced. The external module is not limited to the structural module of the browser, and other modules may be applied.

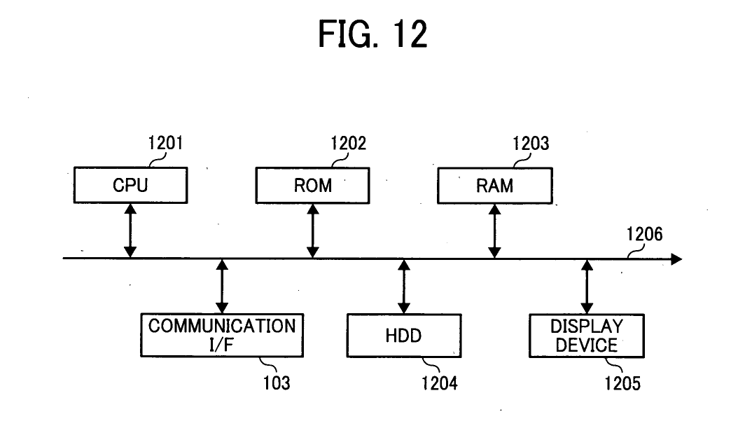

The information processing apparatus 100 of the present embodiment includes, as illustrated in FIG. 12, a CPU 1201, a ROM (Read Only Memory) 1202, a RAM 1203, the communication I/F 103, an HDD 1204 as an external storage device, a display device 1205 such as a display, and a bus 1206 for connecting the above components, and has a hardware structure using a normal computer.

The printer driver program to be executed by the information processing apparatus 100 is provided as being recorded in a computer-readable recording medium, such as a CD-ROM, a flexible disk (FD), a CD-R, or a DVD (Digital Versatile Disk), in an installable or an executable format.

The printer driver program to be executed by the information processing apparatus 100 can be configured so as to be stored in a computer connected to a network such as the Internet so that the computer programs are provided by downloading via the network. The printer driver program to be executed by the information processing apparatus 100 can be configured so as to be provided or distributed via a network such as the Internet.

Furthermore, the printer driver program of the embodiment can be configured so as to be provided as being built in a ROM or the like.

The printer driver program to be executed by the information processing apparatus 100 has a module structure made of the above-mentioned units (the UI driver 121, the graphics driver 123, the language-processing executing unit 124, and the transmitting unit 125). As actual hardware, the CPU 1201 reads the printer driver program from the above-mentioned storage medium and executes them to load the units on the main memory (the RAM 1203), thereby generating the UI driver 121, the graphics driver 123, the language-processing executing unit 124, and the transmitting unit 125 on the RAM 1203.

According to an aspect of the present invention, it is possible to easily change a command for using a printer, so that a workload can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printer driver comprising:
a receiving unit that receives an event for requesting a printer to perform a process;
a command generating unit that generates, when the receiving unit has received the event, a command for causing the printer to execute the event based on a script in which a process for generating the command is written; and
an outputting unit that performs control to output the command generated by the command generating unit to the printer.

2. The printer driver according to claim 1, further comprising:
a determining unit that determines whether a script associated with the event that has been received by the receiving unit is present in a storage unit, wherein
only when the determining unit has determined that the script is present, the command generating unit generates the command based on the script associated with the event.

3. The printer driver according to claim 2, wherein
the determining unit further determines whether the event that has been received by the receiving unit is a predetermined event that requires execution of a script, and
when the determining unit has determined that the event is the predetermined event, the command generating unit generates the command based on the script associated with the event.

4. The printer driver according to claim 1, further comprising:
a passing unit that passes setting information that is related to printing to the script, wherein
the command generating unit generates the command based on the script to which the setting information has been passed by the passing unit.

5. The printer driver according to claim 4, further comprising:
an encrypting unit that performs an encryption process on the setting information which is used with the command, wherein
the passing unit passes the setting information that has been subjected to the encryption process to the script.

6. The printer driver according to claim 1, wherein
the command generating unit functions as an interpreter for executing the script or functions to call a browser for executing the script.

7. An information processing apparatus comprising:
a storage unit that stores therein a script in which a process for generating a command to be executed by a printer is written;
a receiving unit that receives an event for requesting the printer to perform a process;
a command generating unit that generates, when the receiving unit has received the event, the command based on the script stored in the storage unit; and
an outputting unit that performs control to output the command generated by the command generating unit to the printer.

8. The information processing apparatus according to claim 7, further comprising:
a determining unit that determines whether a script associated with the event that has been received by the receiving unit is present in the storage unit, wherein
only when the determining unit has determined that the script is present, the command generating unit generates the command based on the script associated with the event.

9. The information processing apparatus according to claim 8, wherein
the determining unit further determines whether the event that has been received by the receiving unit is a predetermined event that requires execution of a script, and
when the determining unit has determined that the event is the predetermined event, the command generating unit generates the command based on the script associated with the event.

10. The information processing apparatus according to claim 7, further comprising:
a passing unit that passes setting information that is related to printing to the script, wherein
the command generating unit generates the command based on the script to which the setting information has been passed by the passing unit.

11. The information processing apparatus according to claim 10, further comprising:
an encrypting unit that performs an encryption process on the setting information which is used with the command, wherein
the passing unit passes the setting information that has been subjected to the encryption process to the script.

12. The information processing apparatus according to claim 7, wherein
the command generating unit functions as an interpreter for executing the script or functions to call a browser for executing the script.

13. A computer program product comprising a computer-usable medium having computer-readable program codes embodied in the medium for executing the printer driver according to claim 1.
